(19) United States
(12) Patent Application Publication
(10) Pub. No.: US 2006/0149812 A1
(43) Pub. Date: Jul. 6, 2006

(54) System and method for accelerating call setup by caching

(75) Inventors: Yi-Bing Lin, Baoshan Township (TW); Meng-Hsun Tsai, Sinjhuang City (TW); Jen-Shun Yang, Hsinchu City (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsinchu (TW)

(21) Appl. No.: 11/130,096

(22) Filed: May 17, 2005

(30) Foreign Application Priority Data
Dec. 30, 2004 (TW) 093141385

(51) Int. Cl. G06F 15/16

(52) U.S. Cl. 709/203

(57) ABSTRACT

The present invention provides a system and method for accelerating call setup by caching, wherein a user equipment accesses an IMS network via a radio access network and a GPRS core network. The GPRS core network has a HSS recorded with data associated with the user equipment. The IMS network comprises at least one S-CSCF and at least one I-CSCF. The I-CSCF has a cache device. At first, the user equipment sends a register signal which is forwarded to the I-CSCF, and the I-CSCF inquiries the HSS about the services that the user equipment has applied, so as to select an S-CSCF. Then, I-CSCF forwards the register signal to the selected S-CSCF, and the S-CSCF registers to the HSS as being mapped to the user equipment. Finally, when the I-CSCF receives an OK signal, the mapping between the user equipment and the S-CSCF is recorded in the cache device.

### BACKGROUND OF THE INVENTION

1. Field of the Invention

The present invention relates to the technical field of telecommunications, and more particularly, to a system and method for accelerating call setup by caching.

2. Description of Related Art

Currently, based on the universal mobile telecommunications system (UMTS) under the third generation partnership project (3GPP), the IP multimedia core network subsystem (IMS) provides multimedia services by utilizing one of the following three call session control functions (CSCF): proxy-CSCF (P-CSCF), serving-CSCF (S-CSCF) and interrogating-CSCF (I-CSCF). Please refer to FIG. 1, it illustrates the UMTS IMS network architecture. As shown in FIG. 1, the user equipment (UE) 11 can access the IMS network 14 via the radio access network 12 and the GPRS core network 13. There is a home subscriber server (HSS) 131 recorded with various data associated with the UE 11. In the IMS network 14, the P-CSCF 141 is served as the contact point of IMS, such that the user equipment 11 can access the IMS network 14 according to the P-CSCF 141 from the UE location no matter where the user is; the S-CSCF 142 is located in the telecommunications network of the subscriber line so as to provide a variety of multimedia services to the subscriber; and the I-CSCF 143 is adapted to provide fire-wall-like functions so as to hide the interior network configurations of the telecommunications provider.

By taking call service as an example, please refer to the registration procedure as illustrated in FIG. 2. The UE 11 has to send a register signal to the S-CSCF 142 in advance if the user wants to use the call service (S201). Next, the register signal is forwarded to the I-CSCF 143 of the telecommunications network of the subscriber line via the P-CSCF (not shown in FIG. 2) from the UE location. Then, the I-CSCF 143 inquires the HSS 131 about the service request that the UE 11 has applied by exchanging the user authorization request (UAR) signal and the user authorization answer (UAA) signal with the HSS 131 (S202), and selects an appropriate S-CSCF 142 according to the service request (S203). Therefore, the register signal is forwarded to the selected S-CSCF 142 (S204). After receiving the register signal, the S-CSCF 142 registers to the HSS 131 as being mapped to the UE 11 by exchanging the server assignment request (SAR) signal and the server assignment answer (SAA) signal with the HSS 131 (S205), wherein the mapping between the UE 11 and the S-CSCF 142 is recorded in the HSS 131. Finally, the S-CSCF 142 sends an OK signal to the UE 11 via the I-CSCF 143 thereby completing the registration procedure (S206).

Please refer to the call setup flowchart as shown in FIG. 3. When receiving a call request, the invite signal sent by the caller 31 firstly arrives the I-CSCF 143 (S301). Next, the I-CSCF 143 inquires the HSS 131 about the corresponding S-CSCF 142 of the called UE 11 by exchanging the location info request (LIR) signal and the location info answer (LIA) signal with the HSS 131 (S302), and forwards the invite signal to the S-CSCF 142. The S-CSCF 142 then correctly sends the invite signal to the UE 11 according to the location information registered by the user (S303). And the UE 11 replies an offer response signal so as to process the quality of service (QoS) negotiation thereby completing the call setup procedure.

However, in the aforementioned IMS network structure and its registration and call setup procedure, the workload of the HSS 131 is huge because the action of inquiring the HSS 131 (e.g. the I-CSCF 143 exchanges the LIR signal and the LIA signal with the HSS 131) will be triggered whenever receiving each call. Also, the speed of the call setup is decelerated. As a result, it is desirable to provide an improved call setup mechanism of the IMS network.

In U.S. Pat. No. 6,408,181 granted to Ho, et al. for a “Method and system for reducing call setup by roaming number caching”, a cache register is established in the gateway mobile switching center (GMSC) of the global system of mobile communications (GSM) for recording the current location of a called mobile terminal, wherein the current location is the mobile subscriber roaming number (MSRN) including the current mobile switching center (MSC) of the user. Consequently, the frequency of querying the home location register (HLR) is reduced, and the call setup procedure is accelerated. However, once the user moves from an MSC to another MSC and re-registers to the HLR, the cache mechanism is inefficient because the GMSC doesn't realize that the user has re-registered. Therefore, it is desirable to provide a system and method for accelerating call setup by caching to mitigate and/or obviate the aforementioned problems.

### SUMMARY OF THE INVENTION

The object of the present invention is to provide a system and method for accelerating call setup by caching so as to reduce the action of frequently inquiring the HSS by modifying the least network nodes and not reconfiguring various standards when receiving each UMTS IMS call. Further, the present invention is also capable of accelerating the call setup speed and lower the workload of HSS so as to increase the number of users that the HSS can afford.

In accordance with one aspect of the present invention, there is provided a method for accelerating call setup by caching, wherein a user equipment accesses an IP multimedia core network subsystem (IMS) network via a radio access network and a general packet radio service (GPRS) core network, the GPRS core network having an home subscriber server (HSS) recorded with data associated with the user equipment, the IMS network comprising at least one serving-CSCF (S-CSCF) and at least one interrogating-CSCF (I-CSCF), the I-CSCF having a cache device. The method comprises the steps of: (A) the user equipment sending a register signal for registration, the register signal being forwarded to the I-CSCF, such that the I-CSCF inquiring the HSS about at least one service that the user equipment has applied as to select an S-CSCF; (B) the I-CSCF forwarding the register signal to the selected S-CSCF, and the S-CSCF registering to the HSS as being mapped to the user equipment; and (C) the S-CSCF sending an OK signal to the I-CSCF, and the I-CSCF recording the mapping between the user equipment and the S-CSCF in the cache device when receiving the OK signal.

According to another aspect of the present invention, there is provided a system for accelerating call setup by caching, wherein a user equipment accesses an IP multimedia core network subsystem (IMS) network via a radio access network and a general packet radio service (GPRS) core network. The system comprises a home subscriber server (HSS), at least one serving-CSCF (S-CSCF), at least one interrogating-CSCF (I-CSCF), and a cache device. The HSS is located in the GPRS core network for recording data associated with the user equipment. The S-CSCF is located in the IMS network for providing a variety of multimedia services to subscribers. The I-CSCF is located in the IMS network. The cache device is located in the I-CSCF for recording the mapping between the user equipment and the S-CSCF when the user equipment processes a registration procedure for selecting a corresponding S-CSCF. As a result, when a caller sends an invite signal for requesting a call setup with the user equipment, the I-CSCF then checks the cache device and finds the mapping between the user equipment, such that the I-CSCF can directly retrieve the mapping between the user equipment and the S-CSCF from the cache device so as to forward the invite signal to the corresponding S-CSCF.

Other objects, advantages, and novel features of the invention will become more apparent from the following detailed description when taken in conjunction with the accompanying drawings.

### BRIEF DESCRIPTION OF THE DRAWINGS

FIG. 1 depicts a conventional UMTS IMS network architecture;

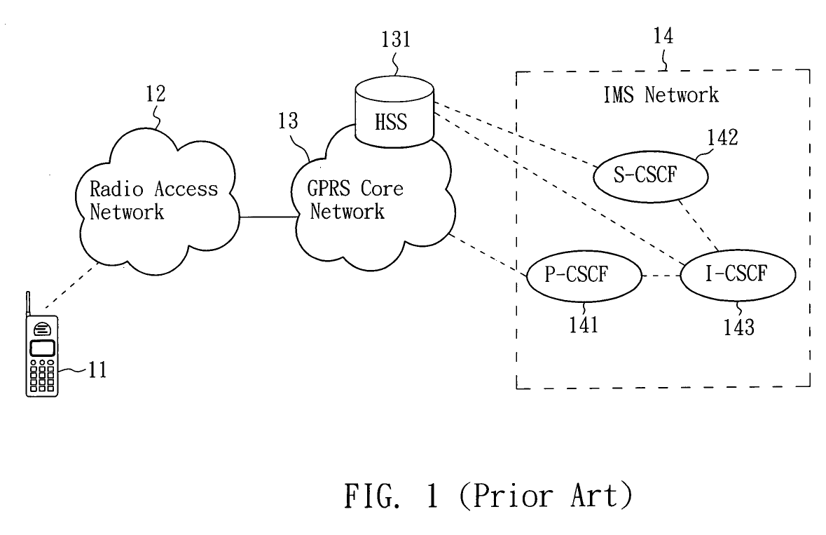

FIG. 2 illustrates a conventional registration procedure according to the specification of 3GPP;

FIG. 3 illustrates a conventional call setup flowchart according to the specification of 3GPP;

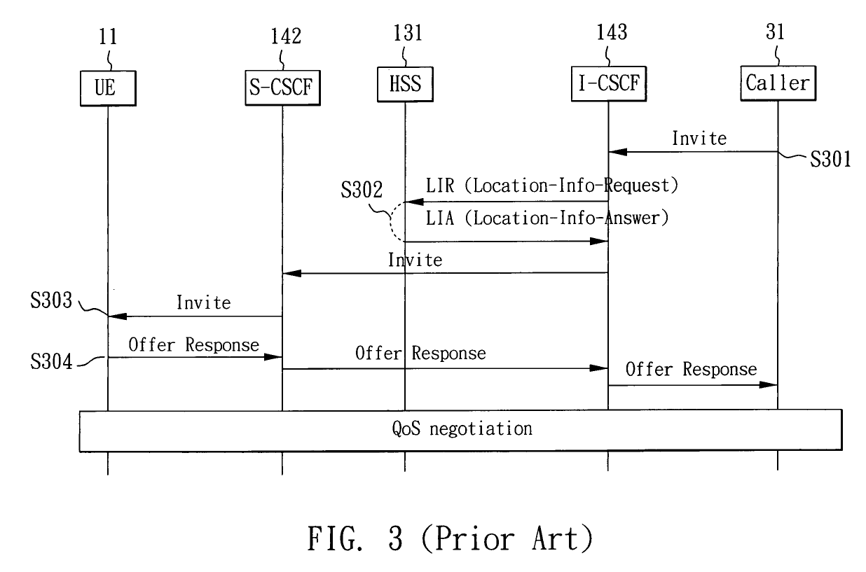

FIG. 4 depicts a network architecture of the system for accelerating call setup by caching of one preferred embodiment according to the present invention;

FIG. 5 illustrates a flowchart of creating cache records during a registration procedure of the preferred embodiment according to the present invention;

FIG. 6 illustrates a flowchart of using cache records during call setup of the preferred embodiment according to the present invention;

FIG. 7 illustrates a flowchart of creating cache records during call setup of the preferred embodiment according to the present invention;

FIG. 8 depicts a cache backup mechanism of the preferred embodiment according to the present invention;

FIG. 9 shows the probability density function of the call setup time according to both the specification of 3GPP and the cache method of the present invention;

FIG. 10 shows the call drop rate variation under different timeout thresholds according to both the specification of 3GPP and the cache method of the present invention; and

FIG. 11 shows the distribution of the first call setup times after the I-CSCF failure according to both the specification of 3GPP and the cache method of the present invention.

### DETAILED DESCRIPTION OF THE PREFERRED EMBODIMENT

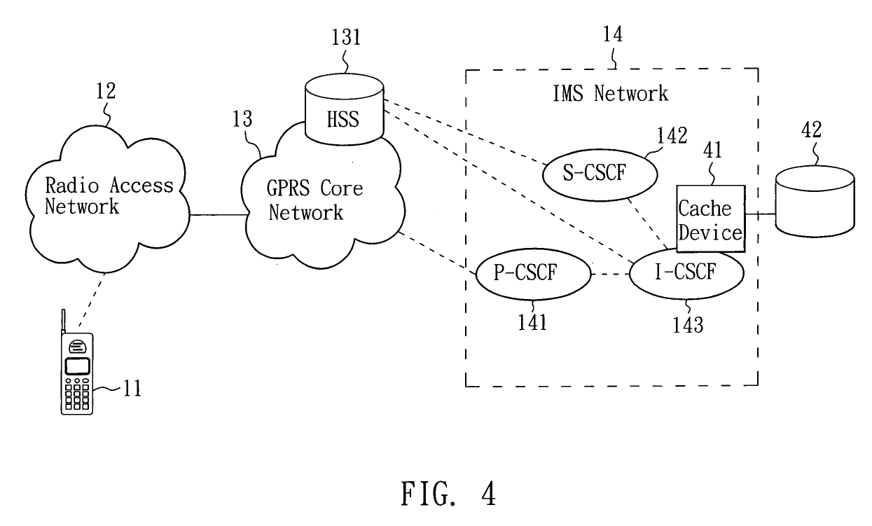

Please refer to FIG. 4. FIG. 4 depicts a network architecture of the system for accelerating call setup by caching in accordance with one preferred embodiment of the present invention. The network architecture depicted in FIG. 4 is similar to the known universal mobile telecommunications system IP multimedia core network subsystem (UMTS IMS) network architecture. That is, the user equipment 11 accesses the IMS network 14 via the radio access network 12 and the general packet radio service (GPRS) core network 13. The home subscriber server (HSS) 131 within the GPRS core network 13 is recorded with various data associated with subscribers. The IMS network 14 provides multimedia services according to at least the following three call session control functions (CSCF): at least one proxy-CSCF (P-CSCF) 141, at least one serving-CSCF (S-CSCF), and at least one interrogating-CSCF (I-CSCF). In the IMS network 14, the P-CSCF 141 is served as the contact point of IMS; the S-CSCF 142 is located in the telecommunications network of the subscriber line so as to provide a variety of multimedia services to the subscriber; and the I-CSCF 143 is adapted to provide fire-wall-like functions so as to hide the interior network configurations of the telecommunications provider. In this embodiment, the I-CSCF 143 has a cache device 41 for providing a cache mechanism to accelerate call setup.

The above cache device 41 located in the I-CSCF 143 is used to record the mapping between the user equipment 11 and the S-CSCF 142. Accordingly, when setting up a call, the necessary S-CSCF 142 information of the user equipment 11 for creating a connection can just be retrieved from the cache device 41 without triggering the action of inquiring the HSS so as to reduce the workload of the HSS.

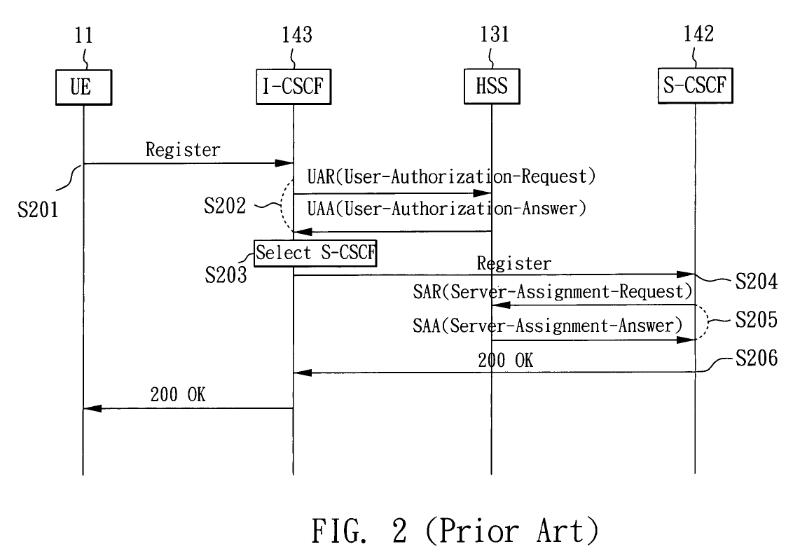

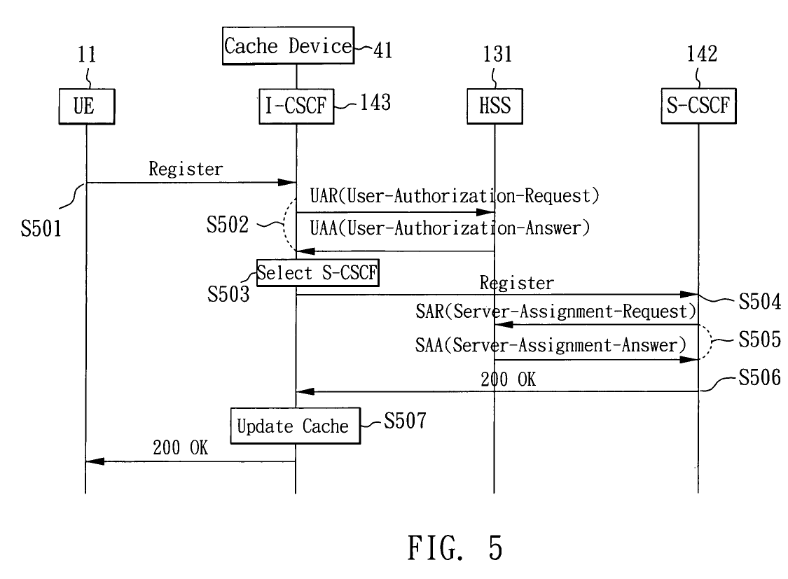

With reference to FIG. 5, which illustrates a flowchart of creating cache records during a registration procedure of the preferred embodiment according to the present invention. It is noted that those signals used during the registration procedure of this embodiment is the same as what mentioned in the registration procedure of FIG. 2. That is, the user equipment 11 firstly sends a register signal for registration (S501). The register signal is then forwarded to the I-CSCF 143, such that the I-CSCF 143 inquires the HSS 131 about the service request that the user equipment 11 has applied by exchanging the user authorization request (UAR) signal and the user authorization answer (UAA) signal with the HSS 131 (S502), and selects an appropriate S-CSCF 142 according to the service request (S503). Therefore, the register signal is forwarded to the selected S-CSCF 142 (S504). After receiving the register signal, the S-CSCF 142 registers to the HSS 131 as being mapped to the user equipment 11 by exchanging the server assignment request (SAR) signal and the server assignment answer (SAA) signal with the HSS 131 (S505). Afterwards, the S-CSCF 142 sends an OK signal (S506). As shown in FIG. 5, when the I-CSCF 143 receives the OK signal, it firstly records the mapping between the user equipment 11 and the S-CSCF 142 in the cache device 41 (S507), and then returns the OK signal back to the user equipment 11. As a result, after the user equipment 11 completes the registration procedure, the mapping between the user equipment 11 and the S-CSCF 142 is successfully established in the cache device 41.

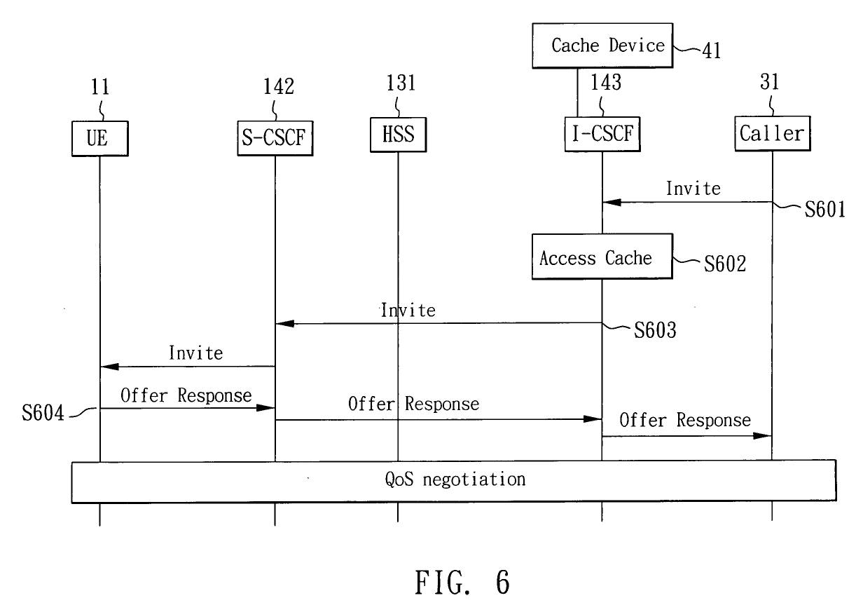

After creating cache records, the acceleration of call setup by caching becomes practicable. Please refer to FIG. 6, which illustrates a flowchart of using cache records during call setup of the preferred embodiment according to the present invention. While an invite signal sent by a caller 31 reaches the I-CSCF 143 (S601), the I-CSCF 143 starts to check whether any mapping between the user equipment 11 and the S-CSCF 142 is stored in the cache device 41 (S602). If so, the I-CSCF 143 is able to directly forward the invite signal to the correct S-CSCF 142 without inquiring the HSS 131, such that the S-CSCF 142 can correctly send the invite signal to the user equipment 11 according to the address information registered by the user equipment 11 (S603). And the user equipment 11 returns an offer response signal so as to complete the call setup procedure (S604).

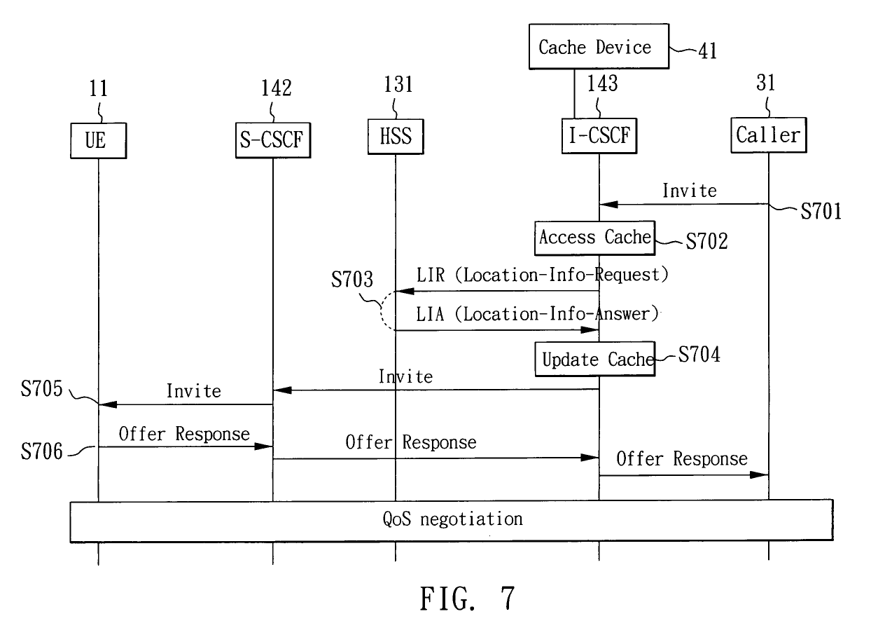

With reference to FIG. 7, FIG. 7 illustrates a flowchart of creating cache records during call setup of the preferred embodiment according to the present invention. After the I-CSCF 143 receives the invite signal sent by the caller 31 (S701), the I-CSCF 143 still starts to check whether any mapping between the user equipment 11 and the S-CSCF 142 is stored in the cache device 41 (S702). If no matching record stored therein, the I-CSCF 143 inquires the HSS 131 about the corresponding S-CSCF 142 of the called user equipment 11 by exchanging a location info request (LIR) signal and a location info answer (LIA) signal with the HSS 131 (S703). And then the I-CSCF 143 records the mapping between the user equipment 11 and the S-CSCF 142 in the cache device 41 (S704). Next, the invite signal is forwarded to the S-CSCF 142, and the S-CSCF 142 correctly sends the invite signal to the user equipment 11 according to the address information registered by the user equipment 11 (S705). Finally, the user equipment 11 returns an offer response signal so as to complete the call setup procedure (S706).

In order to delete the cache records stored in the cache device 41, the user equipment 11 is capable of sending an un-registration signal for deleting the registration information in the S-CSCF 142, and also deleting the user equipment information in the I-CSCF 143 while transmitting the un-registration signal via the I-CSCF 143. Furthermore, the register signal sent by the user equipment 11 can also define an expiring time, which is recorded in the cache device 41 by the I-CSCF 143. If the user equipment 11 doesn't send a re-registration signal or the un-registration signal before the expiring time, the I-CSCF 143 would delete the user equipment information from the cache device 41. Therefore, the life cycle (from the first registration to un-registration or expiration) of the cache record of the I-CSCF 143 is as long as that of the user equipment information. Consequently, no consistency problem would occur in the cache records of the I-CSCF 143, and no garbage data that occupies the storage space would be kept.

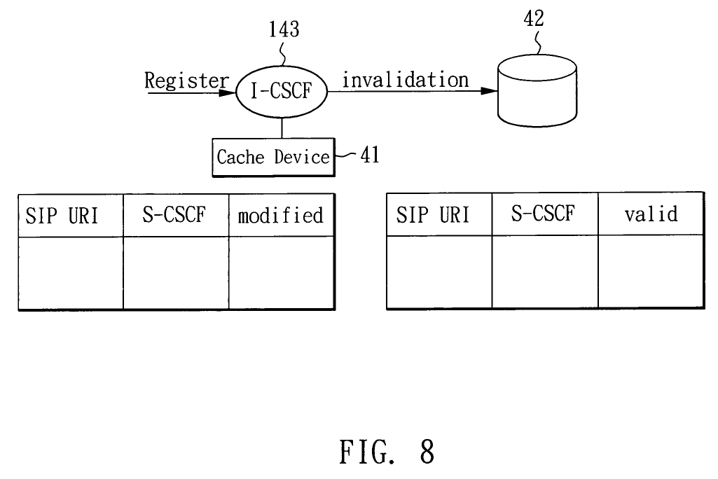

Please refer to FIG. 4 again. The I-CSCF 143 of this embodiment further has a backup server 42 for providing a backup mechanism of the cache records to the I-CSCF 143. The aforementioned backup server 42 periodically makes a backup for modified cache records of the cache device 41 of the I-CSCF 143. In practice, please refer to FIG. 8, each mapping record between the user equipment 11 and the S-CSCF 142 stored in the cache device 41 defines a modified bit for representing whether this record needs for backup. For example, ‘0’ represents that the record doesn't need for backup, while ‘1’ represents that the record needs for backup. Further, each record stored in the backup server 42 defines a valid bit for representing whether the record is valid. For example, ‘0’ represents the record is invalid, while ‘1’ represents the record is valid. At first, the modified bits of all records stored in the cache device 41 are set as ‘0’. When the I-CSCF 143 creates a record, the modified bit of this newly-created record would be set as ‘1’. At the backup time, a backup procedure would be made for all records with modified bits as ‘1’, and the modified bits would then be reset as ‘0’ after finishing the backup procedure. Moreover, during the first cache modification after the backup time, the I-CSCF 143 sends an invalidation signal to inform the backup server 42 to set the valid bit of the first modified cache record as ‘0’ (i.e. invalid), and the valid bit of the first modified cache record would be reset as ‘1’ (i.e. valid) at the next backup time. Consequently, the backup server 42 recovers records with valid bits as ‘1’ after resetting the I-CSCF 143 during the I-CSCF 143 failure, thereby returning to correct records.

Further, because there are large amount of subscribers registered to the current telecommunications network, multiple I-CSCFs 143 should be required to share the workload. Based on such design, for the purpose of making the register signal and each invite signal from the same user equipment 11 pass through the same I-CSCF 143 for achieving the best cache efficiency, the user equipment is allocated to a specific I-CSCF 143 in advance, and the allocation result is recorded in the session initiation protocol uniform resource identifier (SIP URI) of the user equipment 11. For example, the SIP URI of a user equipment (user1) of a telecommunications service provider (operators) is: sip:user1@icscf1.operator1.com. Accordingly, the P-CSCF 141 uses ‘icscf1.operator1.com’ for parsing during the DNS parse procedure. As a result, only the I-CSCF (icscf1) is parsed, such that the register signal and each invite signal from the user equipment (user1) only passes through the I-CSCF (icscf1).

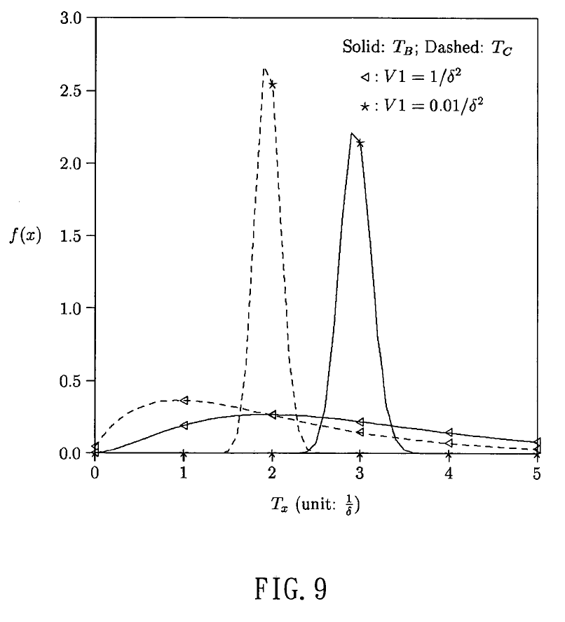

Please refer to FIG. 9 as an explanation of the benefit of the invention. FIG. 9 shows the probability density function of the call setup time TB according to the specification of 3GPP and the call setup time T_{C} according to the cache method of the present invention. The probability density function hypothesizes that: the data transmission time between any two network nodes is in Gamma distribution, the mean is 1/δ, and the variance is V1. As shown in FIG. 9, the distribution range of T_{C} is always in the left of T_{B} no matter how the variance V1 varies. It is obvious that the present invention does accelerate the call setup time.

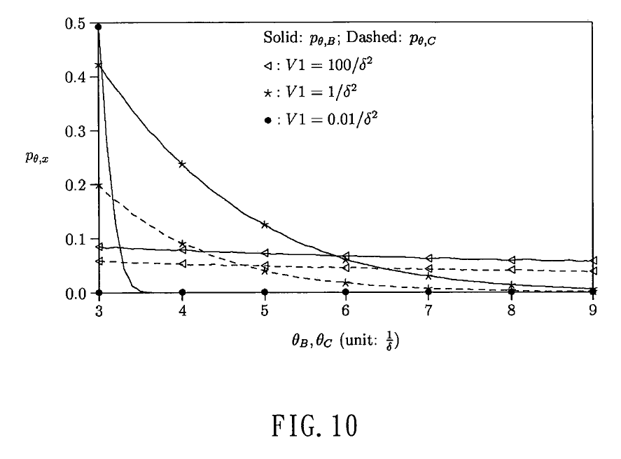

With reference to FIG. 10, which shows the call drop rate variation under different timeout thresholds according to both the specification of 3GPP and the cache method of the present invention. As shown in FIG. 10, the higher the time threshold θₓ, the lower the call drop rate (p_{θ,x}). If a specific call drop rate (e.g. call drop rate is 0.2) is desired under the same V1 (e.g. V1=1/δ²), a horizontal line is used to obtain the time thresholds (e.g. θ_{B} is 4.36, and θ_{C} is 3). It is obvious that the required time threshold of the present invention at the same call drop rate is smaller. Consequently, unusual call setups at the same call drop rate can be detected more quickly according to the present invention.

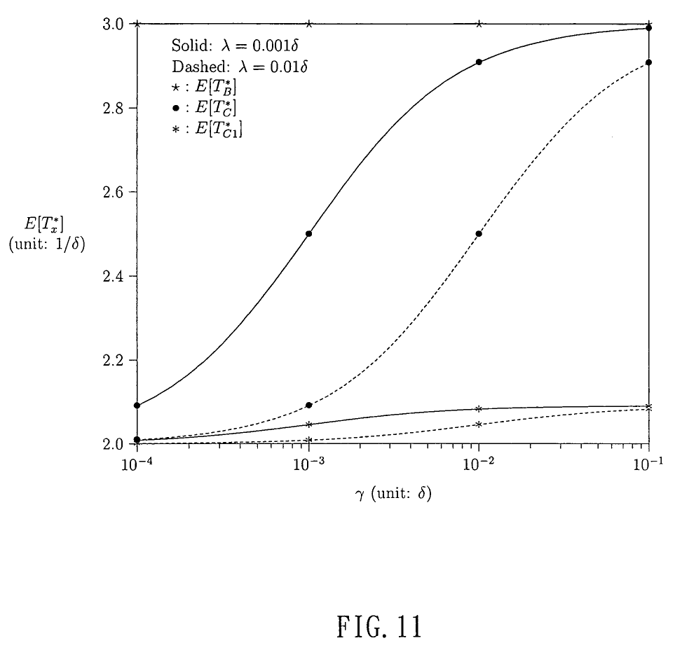

FIG. 11 shows the distribution of the first call setup times after the I-CSCF 143 failure according to both the specification of 3GPP and the cache method of the present invention, wherein E [T*_{B}] is the first call setup time of 3GPP, E[T*_{C}] is the first call setup time without backup of the invention, and E[T*_{C1}] is the first call setup time with backup of the invention. It hypothesizes that: the call arrival is the Poisson arrival, the backup time interval is in exponential distribution, the re-registration time interval is in Gamma distribution, the inter-call arrival time mean is 1/γ, the backup time interval mean is 1/μ, the re-registration time interval mean is 1/λ, the variance is V, μ=10 λ, and V=1/λ². Take the present invention (without backup) as an example, the higher γ, the more E[T*_{C}] close to E [T*_{B}]. It's because that the higher γ is, the higher probability that the invite signal arrives earlier than the register signal. That is, most cache rebuilt is accomplished by inquiring the HSS 131. As shown in FIG. 11, the backup mechanism of the present invention does successfully control the first call setup time after the I-CSCF failure to be less than 2.1/δ.

Although the present invention has been explained in relation to its preferred embodiment, it is to be understood that many other possible modifications and variations can be made without departing from the spirit and scope of the invention as hereinafter claimed.

What is claimed is:

1. A method for accelerating call setup by caching, wherein a user equipment accesses an IP multimedia core network subsystem (IMS) network via a radio access network and a general packet radio service (GPRS) core network, the GPRS core network having a home subscriber server (HSS) recorded with data associated with the user equipment, the IMS network comprising at least one serving-CSCF (S-CSCF) and at least one interrogating-CSCF (I-CSCF), the I-CSCF having a cache device, the method comprising the steps of:
(A) the user equipment sending a register signal for registration, the register signal being forwarded to the I-CSCF, such that the I-CSCF inquiring the HSS about at least one service that the user equipment has applied as to select an S-CSCF;
(B) the I-CSCF forwarding the register signal to the selected S-CSCF, and the S-CSCF registering to the HSS as being mapped to the user equipment; and
(C) the S-CSCF sending an OK signal to the I-CSCF, and the I-CSCF recording the mapping between the user equipment and the S-CSCF in the cache device when receiving the OK signal.

2. The method as claimed in claim 1, wherein in step (A), the I-CSCF inquires the HSS about the service that the user equipment has applied by exchanging a user authorization request (UAR) signal and a user authorization answer (UAA) signal with the HSS.

3. The method as claimed in claim 1, wherein in step (B), the S-CSCF registers to the HSS as being mapped to the user equipment by exchanging a server assignment request (SAR) signal and a server assignment answer (SAA) signal with the HSS.

4. The method as claimed in claim 1, further comprising the following steps:
(D) a caller sending an invite signal for requesting a call setup with the user equipment, the I-CSCF checking the cache device and finding the mapping between the user equipment and the S-CSCF when the invite signal being sent to the I-CSCF, thereby the I-CSCF directly retrieving the mapping between the user equipment and the S-CSCF from the cache device, and forwarding the invite signal to the corresponding S-CSCF; and
(E) the S-CSCF correctly sending the invite signal to the user equipment according to the address information registered by the user equipment, and the user equipment returning an offer response signal so as to complete the call setup.

5. The method as claimed in claim 1, further comprising the following steps:
(F) a caller sending an invite signal for requesting a call setup with the user equipment, the I-CSCF checking the cache device but not finding the mapping between the user equipment and the S-CSCF when the invite signal being sent to the I-CSCF, thereby the I-CSCF inquiring the HSS about the corresponding S-CSCF of the called user equipment;
(G) the I-CSCF recording the mapping between the user equipment and the S-CSCF in the cache device, and forwarding the invite signal to the S-CSCF; and
(H) the S-CSCF correctly sending the invite signal to the user equipment according to the address information registered by the user equipment, and the user equipment returning an offer response signal so as to complete the call setup.

6. The method as claimed in claim 5, wherein in step (F), the I-CSCF inquiries the HSS about the corresponding S-CSCF of the called user equipment by exchanging a location info request (LIR) signal and a location info answer (LIA) signal with the HSS.

7. The method as claimed in claim 1, further comprising the step of:
(I) the user equipment sending an un-registration signal for deleting the registration information in the S-CSCF, and also deleting the user equipment information in the I-CSCF while transmitting the un-registration signal via the I-CSCF.

8. The method as claimed in claim 1, wherein in step (A), the register signal sent by the user equipment has an expire time which is recorded in the cache device by the I-CSCF, such that the I-CSCF deletes the user equipment information from the cache device if the user equipment doesn't send a re-registration signal or the un-registration signal before the expire time.

9. The method as claimed in claim 1, further comprising the step of:
(J) periodically making a backup for modified cache records of the cache device so as to recover the modified cache records to the cache device after resetting the I-CSCF during an I-CSCF failure.

10. The method as claimed in claim 9, wherein in step (J), all modified cache records are stored to a backup server at a backup time, after the backup time, the I-CSCF informs the backup server to set the cache record as invalid for the first modification of this record and the modified cache record would be stored to the backup server and reset as valid at the next backup time, such that the backup server recovers valid records after resetting the I-CSCF during the I-CSCF failure.

11. The method as claimed in claim 1, wherein the user equipment is allocated to the I-CSCF in advance, and an allocation result is recorded in the user equipment.

12. A system for accelerating call setup by caching, wherein a user equipment accesses an IP multimedia core network subsystem (IMS) network via a radio access network and a general packet radio service (GPRS) core network, the system comprising:
a home subscriber server (HSS) located in the GPRS core network for recording data associated with the user equipment;
at least one serving-CSCF (S-CSCF) located in the IMS network for providing a variety of multimedia services to subscribers;
at least one interrogating-CSCF (I-CSCF) located in the IMS network; and
a cache device located in the I-CSCF for recording the mapping between the user equipment and the S-CSCF when the user equipment processes a registration procedure for selecting a corresponding S-CSCF, such that when a caller sends an invite signal for requesting a call setup with the user equipment, the I-CSCF checks the cache device and finds the mapping between the user equipment and the S-CSCF, thereby the I-CSCF directly retrieving the mapping between the user equipment and the S-CSCF from the cache device so as to forward the invite signal to the corresponding S-CSCF.

13. The system as claimed in claim 12, further comprising:
a backup server for periodically making a backup for modified cache records of the cache device so as to recover the modified cache records to the cache device after resetting the I-CSCF during an I-CSCF failure.

14. The system as claimed in claim 13, wherein all cache records are stored to the backup server at a backup time, after the backup time, the I-CSCF informs the backup server to set the cache record as invalid for the first modification of this record, and the modified cache record would be stored to the backup server and reset as valid at the next backup time, such that the backup server recovers valid records after resetting the I-CSCF during the I-CSCF failure.

15. The system as claimed in claim 12, wherein the user equipment is allocated to the I-CSCF in advance, and an allocation result is recorded in the user equipment.
